(19) United States
(12) Patent Application Publication
(10) Pub. No.: US 2018/0011608 A1
(43) Pub. Date: Jan. 11, 2018

(54) SYSTEM AND METHOD FOR OPTIMIZING WEBSITE CREATION TOOLS BASED ON USER CONTEXT

(71) Applicant: IM Creator Ltd., New York, NY (US)

(72) Inventor: Jonathan SARAGOSSI, Tel Aviv (IL)

(73) Assignee: IM Creator Ltd., New York (NY)

(21) Appl. No.: 15/641,847

(22) Filed: Jul. 5, 2017

Related U.S. Application Data
(60) Provisional application No. 62/358,620, filed on Jul. 6, 2016.

(51) Int. Cl. G06F 3/0481; H04L 29/08

(52) U.S. Cl. CPC G06F 3/0481; H04L 67/02; H04L 67/22

(57) ABSTRACT

A system and method for optimizing website creation tools based on user context. The method includes accessing information from a user device, wherein the user information includes a direct user input; analyzing the user information to determine a user context; and generating a website development dashboard for display, wherein the website development dashboard includes at least one website development tool selected based on the determined user context.

### CROSS-REFERENCE TO RELATED APPLICATIONS

This application claims the benefit of U.S. Provisional Application No. 62/358,620 filed on Jul. 6, 2016, the contents of which are hereby incorporated by reference.

### TECHNICAL FIELD

The present disclosure relates generally to website creation and more particularly to a system and method for optimizing website creation tools based on user context.

### BACKGROUND

The Internet currently plays a large role in modern society, providing an easily accessible space for expression. Corporations and individuals alike use the Internet to create publicly available content that can be accessed by potential customers or readers and those interested in learning more about them, often by creating websites. A website is a set of related webpages typically served from a single web domain, which is accessible through a browser and enable entities both big and small to easily promote their goods, services and opinions on the Internet.

Currently, there are various methods available to those interested in building a website. One method involves employing an individual, such as web developer, who is hired to create a website for their customer. Web developers offer the ability to customize the look and feel of a website, and can offer design and technical suggestions. Additionally, they can respond to requests and feedback from a website owner and discuss various possible paths to take in the creation and maintenance of the website. However, finding a qualified individual to create a website can be difficult, and the process can become expensive. Cost tends to be a barrier for small enterprises and sole practitioners wishing to develop a tailored website. Furthermore, while having a blank slate with endless design and technical options provides much possibility, it can make the website creation process time consuming and arduous, often requiring a user to review many more options than may be necessary or appropriate for their needs.

An alternative to hiring a web developer to create a website is to use an automated website creation service. While these services can set up a website within a quicker time frame, they often only offer generic templates that are best suited to some, and are limited with significant shortcomings to others. Users may have to peruse through many tools and templates to find ones that are suitable for their purposes. These services can take significant energy and time to navigate. Often relevant tools and options for a specific website purpose are missing, as an automated website creation system can only provide a limited amount of options aimed more toward generality than customized solutions. Another disadvantage of these services is that many do not differentiate between users based on demographics, such as location, which can impact how an optimized website should be designed.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for optimizing website creation tools based on user context, the method comprising: accessing information from a user device, wherein the user information includes a direct user input; analyzing the user information to determine a user context; and generating a website development dashboard for display, wherein the website development dashboard includes at least one website development tool selected based on the determined user context.

Certain embodiments disclosed herein also include a non-transitory computer readable medium having stored thereon causing a processing circuitry to execute a process, the process comprising: accessing information from a user device, wherein the user information includes a direct user input; analyzing the user information to determine a user context; and generating a website development dashboard for display, wherein the website development dashboard includes at least one website development tool selected based on the determined user context.

Certain embodiments disclosed herein also include a system for dynamically displaying traffic information of a website on a visual dashboard, the system comprising: a processing circuitry; and a memory, the memory containing instructions that, when executed by the processing circuitry, configure the system to: access information from a user device, wherein the user information includes a direct user input; analyze the user information to determine a user context; and generate a website development dashboard for display, wherein the website development dashboard includes at least one website development tool selected based on the determined user context.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 shows a network diagram utilized to describe the various embodiments related to optimizing website creation tools based on user context.

FIG. 2 shows a flowchart describing a method for optimizing website creation tools based on user context according to an embodiment.

FIG. 3 shows a visual representation of a website development dashboard rendered according to an embodiment.

FIG. 4 shows a block diagram of a context generator according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for optimizing website creation tools based on user context. In an embodiment, the user context is determined based on user input and acquired user data. The system provides tools for customizing the visual and functional aspects of a website based on the user context.

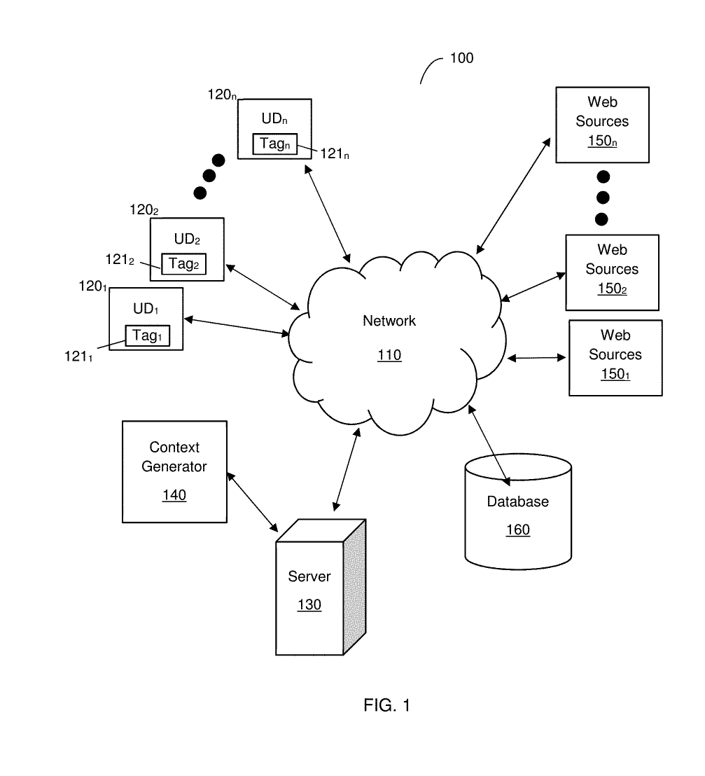

FIG. 1 shows an example network diagram 100 of the system for optimizing website creation tools based on user context according to an embodiment. The network diagram 100 depicts one or more user devices (120₁-120ₙ, hereinafter referred to collectively or singularly as 120 for simplicity purposes), a server 130, a context generator 140, and one or more web sources (150₁-150ₙ, hereinafter referred to collectively or singularly as 150 for simplicity purposes), connected through a network 110. The network 110 may be, but is not limited to, the Internet, the world-wide-web (WWW) and other networks capable of enabling communication between the elements of the network diagram 100.

The user device 120 may be, but is not limited to, a personal computer (PC), a personal digital assistant (PDA), a mobile phone, a smart phone, a tablet computer, a wearable computing device and other wired and mobile computing devices, equipped with browsing, viewing, and other capabilities of interacting with and accessing websites and servers.

The server 130 includes a processing unit, such as, a processor (not shown). The processor is coupled to a memory. The memory contains therein instructions that when executed by the processor results in the generation of customized website development tools as further described hereinabove and below.

The context generator (CG) 140 may be further connected to the server 130. The context generator 140 may be connected directly to the server or connected thereto via the network 110. According an embodiment, the context generator 140 is comprised in the server 130. The context generator 140 is configured to determine a user context to provide tools for website development by a user of the user device 120.

Optionally, the system further comprises a database 160. The database 160 contains therein data associated with certain users, user devices, websites and their respective context. Such data may include, for example, user location, user browsing history, website performance, e.g., visitors, revenue, conversion rates, stylistic elements, employed application programming interfaces (APIs), and other user and website characteristics.

When a user device 120 accesses the server 130 in order to create a website, the server 130 is configured to collect information regarding that user device 120 and relay the collected information to the context generator 140. Collected information includes direct user input as well as user data acquired automatically from the user device 120. In a non-limiting example, when a user device 120 accesses a server 130 though the network 110, a tag (121₁-121ₙ, hereinafter referred to collectively or singularly as 121 for clarify purposes) is sent to the user device 130. In one embodiment, the tag 121 is sent from the server 130. The tag 121 may include a cookie, a script, or similar piece of software code designed to access and acquire data regarding the user device 120, including but not limited the location of the user device 120, past browsing or search history of the user device 120, online accounts associated with the user device 120, and so on.

The server 130 is configured to access the tags 121, Internet protocol (IP) addresses, or any other relevant data associated with the user device 120 that would assist in determining the user context. In one embodiment, this collected information is stored within the server 130. In an alternative embodiment, the collected information is stored in the database 160 an accessible by the server 130.

As will be discusses below, the collected information association with the user device 120 is sent to the context generator 140 and analyzed in order to determine the context in which a user may desire to create a website. In an embodiment, once a user context is determined for a particular user device 120, a profile is created linking the characteristics of the user device 120 with a context, where the profile can be stored within the database 160 for future reference.

The context generator 140 may additionally access previously stored profiles within the database 160 that are determined to match the collected information to assist the determination of user context. Additionally, various web sources 150 may be accessed to determine user context, where the web sources 150 include website management tools, databases, search engines, etc. that are accessible by the server 130 and can provide web development tools or metadata associated thereto responsive to a query provided by the server 130.

The user context for the website may include, but it not limited to, desired audience of the website, desired locale where it will mainly be used, type of website, e.g. commercial, personal, informative, non-profit organization, and the like, anticipated traffic size, required server load and so on.

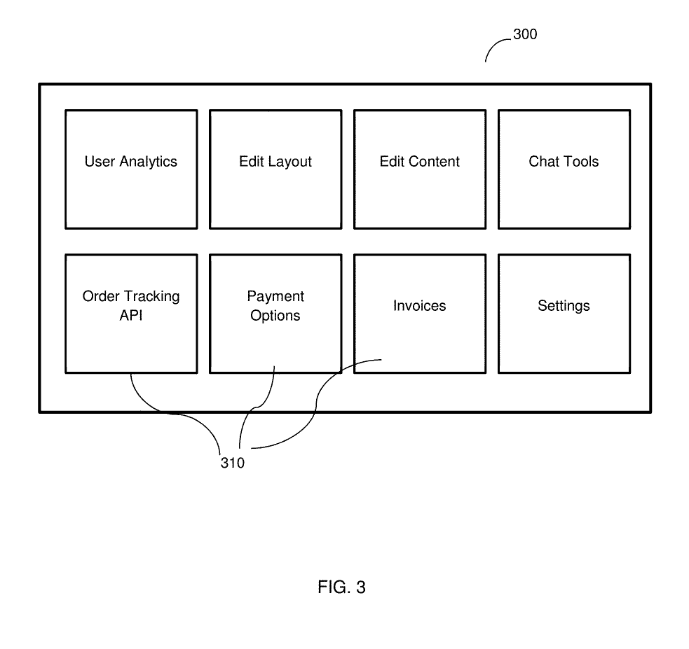

Based on the determined user context, the server 130 generates a website's development dashboard that includes a plurality of tools. The dashboard is further described herein below with respect of FIG. 3. In an embodiment, after determining the user context, a dashboard is caused to be displayed on the user device 120. Throughout the development of the website, the website is continuously monitored by the context generator 140 in order to identify any changes to the context. If the context does change while the website is functioning, the website development tools may be adaptively customized by the context generator 140 to reflect the current context.

It should be understood that the embodiments disclosed herein are not limited to the specific architecture illustrated in FIG. 1 and that other architectures may be equally used without departing from the scope of the disclosed embodiments. Specifically, the context generator 140, server 130 and/or database 160 may reside in the cloud computing platform, a different cloud computing platform, or a datacenter. Moreover, in an embodiment, there may be a plurality of context generators 140, servers 130 and/or databases 140 operating as described hereinabove and configured to either have one as a standby, to share the load between them, or to split the functions between them.

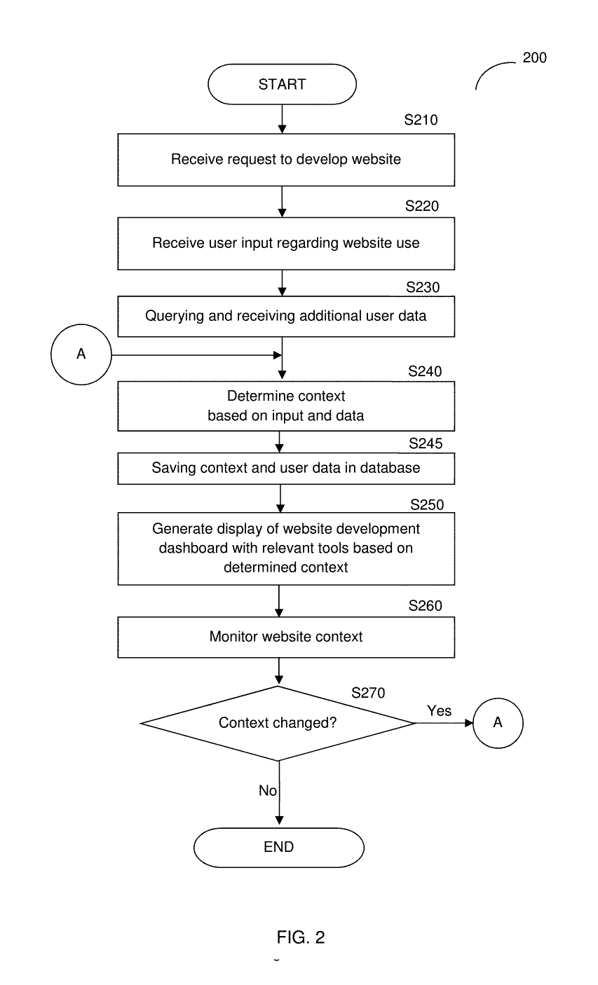

FIG. 2 shows an exemplary and non-limiting flowchart 200 describing an operation of a method for optimizing website creation tools based on user context according to an embodiment.

At S210, a request to develop a website is received, e.g. from a user device. The request can be initiated when a user accesses a server and indicates a desire to set up a website. For example, a user may visit a website creation service hosted on the server, and indicate that they wish to create a website.

At S220, user input regarding the website is received. The user input may include user generated answers to one or more questions sent to the user. For example, a user may be presented to complete an online questionnaire regarding the intended purpose of the website, the planned audience of the website, and type of content to be displayed on the website, and the like. Additionally, the user may offer access to external online accounts, such as social media accounts, which can be used to determine the type of website they wish to develop and audience they wish to reach.

At S230, additional user data is acquired. The user data includes acquiring information related to the user or user device. The acquired user data may include information gathered by a tag, as described above regarding FIG. 1, or other methods that are automatically retrieved without additional user input. For example, an IP address, browsing history, and location can be used to determine the context of the website to be developed. In some embodiments, a query is sent from the server to a user device requesting the additional user data.

At S240, the context of the website to be developed is determined based on the collected information, comprising the direct user input and the automatically acquired user data. As a non-liming example, if a user has a browsing history and external online accounts associated with photography, and has answered a questionnaire indicating that they wish to start a small business, the context of the website may be determined to be that of a professional photographer interested in selling photography services online. In an embodiment, after the user context is determined, the user is presented with the option to tweak and amend the determined context.

At optional S245, the context and user data are stored for future reference, for example in a database. The context and user data can be used for future analysis to determine context of websites from users and user devices having similar collected information.

At S250, a website development dashboard is generated and caused to be displayed on the user device. The website development dashboard, as will be explained further in with regard to FIG. 3. hereinbelow, presents a visual display offering various tools for website development that is customized to the determined context.

At optional S260, after a website has been created, the context of the website can be monitored using the user data as well as evaluating the usage of the website, such as traffic and location of visitors and updated elements within the website. At S270, if the context is determined to have changed, the process returns to S240 to reevaluate and offer an updated relevant website development dashboard to the user device. If the context has not changed, the process ends.

FIG. 3 depicts a visual representation of a website development dashboard 300 rendered according to an embodiment. In the depicted embodiment, the website development dashboard 300 includes a plurality of cells 310 representing various website design and management tools.

In a non-limiting example, the context for a website has been determined to be for commercial purposes, e.g. by the method disclosed above with respect to FIG. 3. A context generator is configured to select relevant website development tools that are presented in a visual representation such as a dashboard, where each website development tool is placed within a cell 310. For commercial websites, relevant website development tools can include a payment application programming interface system, an invoice tracking system, a user chart system, a user analytics system, an online interactive chat system configured to interact with current and potential clients, edit and control order tracking APIs, and the like. Alternatively, for an educational website, the relevant website development tools may include a progress tracking system for students, a knowledge testing system, and a user analytics system.

Each of the tools presenting within the cells 310 can be modified and replaced with alternative tools if the context of the website is determined to be something else. Following the aforementioned example, if a website it initially set up to sell photography services, but then changes to offer informative online classes teaching photography skills, the website development tools may change to reflect such a transition. Thus, the order tracking API can be removed and replaced with a course tracking tool configured to allow students to save their progress through a photography lesson.

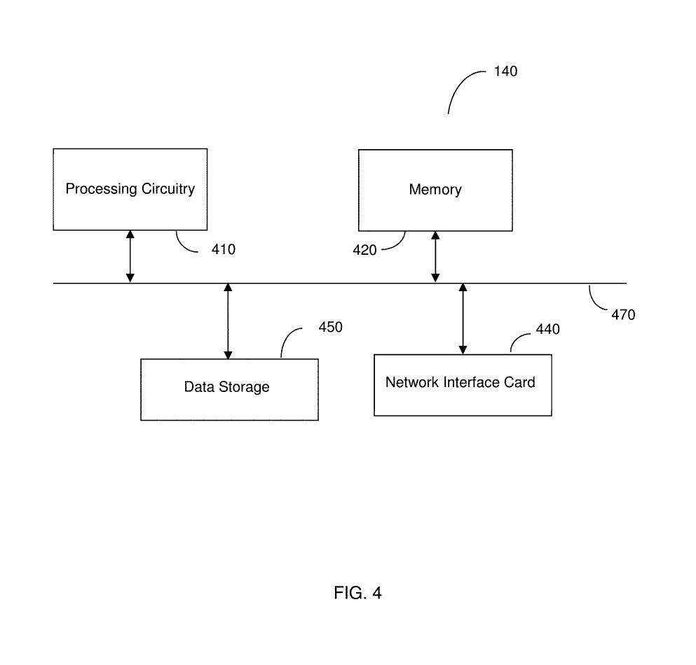

FIG. 4 depicts an example embodiment of the context generator 140 for optimizing website creation tools based on user context. The context generator 140 includes a processing circuitry 410 coupled to a memory 420 and a network interface (NIC) 440.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), graphics processing unit (GPUs) and the like, or any other hardware logic components that can perform calculations or other manipulations of information.

The memory 420 contains therein instructions that when executed by the processing circuitry 410 results in the determination of user context and generation of a website development dashboard and described herein. Specifically, the memory 420 may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code).

The processing circuitry 410 is further coupled to a data storage unit 450 configured to store data related to a user or user device, including browsing history, linked online accounts, location and other relevant data.

The processing circuitry 410 is further coupled to a network interface card (NIC) 440 that is configured to be operably connected to a network (not shown) that allows a context generator 140 to access servers and/or user devices. The various elements of the context generator 140 may be connected via a bus 470.

It should be noted that systems that provide software as a service (SaaS) are specifically included herein. In such systems, computations may be done by a remote server that enables the determination of context, and as may be applicable to the corresponding input means (e.g. mobile device, desktop device, etc.), which can be observed and/or controlled by a remote administrator, remote operator and/or a client/user. Hence each of the elements shown in FIG. 4 may be moved in whole, in part, or otherwise duplicated in whole or in part at a remote location and communicatively coupled over a network. The network may comprise a local area network (LAN), wide area network (WAN), metro area network (MAN), the worldwide web (WWW), and the likes, whether wired or wireless.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

What is claimed is:

1. A method for optimizing website creation tools based on user context, comprising:
accessing information from a user device, wherein the user information includes a direct user input;
analyzing the user information to determine a user context;
generating a website development dashboard for display, wherein the website development dashboard includes at least one website development tool selected based on the determined user context.

2. The method of claim 1, wherein the at least one website development tool includes any one of: a commercial website tool, an educational website tool, an informational website tool.

3. The method of claim 2, wherein the commercial website tool includes any one of: a payment application programming interface system, an invoice tracking system, a user chart system, a user analytics system.

4. The method of claim 2, wherein the educational website tool includes any one of: a progress tracking system, a knowledge testing system, a user analytics system.

5. The method of claim 1, wherein the user information further includes user data automatically acquired from a user device.

6. The method of claim 5, wherein the acquired user data comprise: an internet protocol (IP) address of a user device, a user's browsing history, a user's location.

7. The method of claim 1, further comprising:
monitoring a website for changes to the user context.

8. The method of claim 7, further comprising:
generating an updated website development dashboard with website development tools based on the changes to the user context.

9. The method of claim 1, further comprising:
storing the user information and the determined user context in a database.

10. A non-transitory computer readable medium having stored thereon instructions for causing a processing circuitry to execute a process, the process comprising:
accessing information from a user device, wherein the user information includes a direct user input;
analyzing the user information to determine a user context;
generating a website development dashboard for display, wherein the website development dashboard includes at least one website development tool selected based on the determined user context.

11. A system for dynamically displaying traffic information of a website on a visual dashboard, the system comprising:
a processing circuitry; and
a memory, the memory containing instructions that, when executed by the processing circuitry, configure the system to:
access information from a user device, wherein the user information includes a direct user input;
analyze the user information to determine a user context;
generate a website development dashboard for display, wherein the website development dashboard includes at least one website development tool selected based on the determined user context.

12. The system of claim 11, wherein the at least one website development tool comprises any one of: a commercial website tool, an educational website tool, an informational website tool.

13. The system of claim 12, wherein the commercial website tool includes any one of: a payment application programming interface system, an invoice tracking system, a user chart system, a user analytics system.

14. The system of claim 12, wherein the educational website tool includes any one of: a progress tracking system, a knowledge testing system, a user analytics system.

15. The system of claim 11, wherein the user information further includes user data automatically acquired from a user device.

16. The system of claim 15, wherein the acquired user data comprise: an internet protocol (IP) address of a user device, a user's browsing history, a user's location.

17. The system of claim 11, wherein the system is further configured:
monitor a website for changes to the user context.

18. The system of claim 17, wherein the system is further configured:
generate an updated website development dashboard with website development tools based on the changes to the user context.

19. The system of claim 11, wherein the system is further configured:
store the user information and the determined user context in a database.
